(19) United States
(12) Patent Application Publication
(10) Pub. No.: US 2019/0155812 A1
(43) Pub. Date: May 23, 2019

(54) METHOD, DEVICE, AND NON-TRANSITORY COMPUTER-READABLE RECORDING MEDIUM STORING COMPUTER PROGRAM FOR PROVIDING CONTENT

(71) Applicant: Snow Corporation, Seongnam-si (KR)

(72) Inventors: Sang Chul HAN, Seongnam-si (KR); Hyeong Bae SHIN, Seongnam-si (KR)

(73) Assignee: Snow Corporation, Seongnam-si (KR)

(21) Appl. No.: 16/227,671

(22) Filed: Dec. 20, 2018

Related U.S. Application Data
(63) Continuation of application No. PCT/KR2016/006507, filed on Jun. 20, 2016.

(51) Int. Cl. G06F 16/2457; G06F 16/28; G06F 16/22; G06F 16/248; G06F 16/23

(52) U.S. Cl. CPC G06F 16/24578; G06F 16/285; G06F 16/2379; G06F 16/248; G06F 16/2228

(57) ABSTRACT

A content providing method including acquiring an operation signal with respect to operation content, calculating, according to the operation signal, at least one of an operation time that is time spent for performing an operation or an operation frequency corresponding to the operation signal, updating an operation index of the operation content with respect to at least one operation category corresponding to the operation, based on at least one of the operation time or the operation frequency, and determining a ranking of the at least one operation content with respect to the operation category, based on the operation index may be provided.

### CROSS-REFERENCE TO RELATED APPLICATIONS

This U.S. non-provisional application is a continuation application of, and claims the benefit of priority under 35 U.S.C. § 365(c) from International Application PCT/KR2016/006057 filed on Jun. 20, 2016, the entire content of which is incorporated herein by reference.

### BACKGROUND

The present disclosure relates to methods, devices, and/or non-transitory computer-readable recording media storing a computer program for performing a content providing method.

Due to developments in information and communication technology, various types of terminals such as mobile communication terminals or personal computers are being implemented to perform various functions.

Mobile communication terminals, as an example, have been implemented to perform not only a basic voice communication function, but also recently various functions such as data communication, image capturing or video shooting using a camera, playback of music or video files, gaming, and/or broadcasting.

The functionality of the mobile terminals is being continuously increased due to improvements in software technology as well as in hardware technology.

Recently, some mobile terminals have performance exceeding that of personal computers (PCs). Accordingly, various types of objects (e.g., photos, videos, documents, and/or text) to be recognized by a PC can also be handled in such mobile terminals. Further, the amount of content stored in these terminals is increasing. Accordingly, a more efficient content management method is needed.

### SUMMARY

Some example embodiments of the present disclosure provide content providing methods, devices, and non-transitory computer-readable recording media storing a computer program for determining a content providing order in consideration of a time for operating content and an operation frequency of content, and providing users with content according to a determined order.

Furthermore, some example embodiments of the present disclosure provide content providing methods, devices, and non-transitory computer-readable recording media storing a computer program for providing content by classifying the content according to operation categories.

Furthermore, some example embodiments of the present disclosure provide content providing methods, devices, and non-transitory computer-readable recording media storing a computer program for identifying a category to which a user's current operation belongs and changing a content providing order according to a category of the current operation, thereby providing content in accordance with a user's intention.

According to an aspect of the present disclosure, a non-transitory computer-readable recording medium storing a computer program that, when executed by a computer, causes the computer to perform a method. The method may include acquiring an operation signal with respect to operation content, calculating, according to the operation signal, at least one of an operation time or an operation frequency corresponding to the operation signal, the operation time being time spent for performing an operation, updating an operation index of the operation content with respect to at least one operation category corresponding to the operation, based on at least one of the operation time or the operation frequency, and determining a ranking of the operation content with respect to the at least one operation category, based on the operation index.

According to an aspect of the present disclosure, a content providing method includes acquiring an operation signal with respect to operation content, calculating, according to the operation signal, at least one of an operation time or an operation frequency corresponding to the operation signal, the operation time being time spent for performing an operation, updating an operation index of the operation content with respect to at least one operation category corresponding to the operation, based on at least one of the operation time or the operation frequency, and determining a ranking of the operation content with respect to the at least one operation category, based on the operation index.

According to an aspect of the present disclosure, a content providing device includes a communication unit configured to receive from a user terminal an operation signal with respect to operation content, and a controller that is configured to calculate, according to the operation signal, at least one of an operation time or an operation frequency corresponding to the operation signal, the operation time being time spent for performing an operation, update an operation index of the operation content with respect to at least one operation category corresponding to the operation, based on at least one of the operation time or the operation frequency, and determine a ranking of the operation content with respect to the at least one operation category, based on the operation index.

These and/or other aspects will become apparent and more readily appreciated from the following drawings, claims, and the description of the example embodiments.

According to some example embodiments of the present disclosure, content providing methods, devices, and non-transitory computer-readable recording media storing a computer program for determining a content providing order, in consideration of the user's operation time and operation frequency of each of a plurality of pieces of content, and providing users with content according to a determined order, thereby enabling a faster search for desired content without an additional operation.

Furthermore, some example embodiments of the present disclosure may provide content according to a user's needs by classifying the content according to each operation category.

Furthermore, some example embodiments of the present disclosure may provide content providing methods, devices, and non-transitory computer-readable recording media storing a program for providing content according to a user's intention by identifying a category to which a user's current operation belongs and changing a content providing order according to the category of the current operation.

### BRIEF DESCRIPTION OF THE DRAWINGS

FIGS. 1 and 2 illustrate a configuration of a user terminal according to a first example embodiment of the present disclosure.

FIGS. 3A to 3D are flowcharts of content providing method performed by the user terminal, according to the first example embodiment of the present disclosure.

FIG. 4 illustrates a configuration of content providing system according to a second example embodiment of the present disclosure.

FIG. 5 is a block diagram of a configuration of content providing device provided in a server of FIG. 4, according to an example embodiment.

FIG. 6 is a flowchart of a method of processing information between a server and a user terminal according to an example embodiment.

FIG. 7 illustrates a screen showing content displayed on a display unit of a user terminal, according to an example embodiment of the present disclosure.

FIG. 8 illustrates a screen in which a content providing method according to an example embodiment of the present disclosure is applied to a messenger application.

FIG. 9 illustrates a screen on which content is provided for each operation category on the display unit of the user terminal, according to an example embodiment of the present disclosure.

FIG. 10 illustrates a screen in which a content providing method according to an example embodiment of the present disclosure is applied to a messenger application.

### DETAILED DESCRIPTION

As the disclosure allows for various changes and numerous example embodiments, some example embodiments will be illustrated in the drawings and described in detail in the written description. However, the disclosed example embodiments are not intended to limit the present disclosure to particular modes of practice, and it is to be appreciated that all changes, equivalents, and substitutes that do not depart from the spirit and technical scope of the present disclosure are encompassed in the present disclosure.

The present disclosure will now be described more fully with reference to the accompanying drawings, in which some example embodiments of the disclosure are shown. Throughout the drawings, like reference numerals denote like elements. In the following description, when detailed descriptions about related well-known functions or structures are determined to make the gist of the present disclosure unclear, the detailed descriptions will be omitted herein.

In the following embodiment, terms such as “first” and “second” are used herein merely to describe a variety of constituent elements, but the constituent elements are not limited by the terms. An expression used in a singular form in the present specification also includes the expression in its plural form unless clearly specified otherwise in context. Also, terms such as “include” or “comprise” may be construed to denote a certain characteristic or a constituent element, but may not be construed to exclude the existence of or a possibility of addition of one or more other characteristics or constituent elements. Sizes of components in the drawings may be exaggerated for convenience of explanation. In other words, since sizes and thicknesses of components in the drawings are arbitrarily illustrated for convenience of explanation Example embodiments of the present disclosure are not limited to the example embodiments disclosed herein.

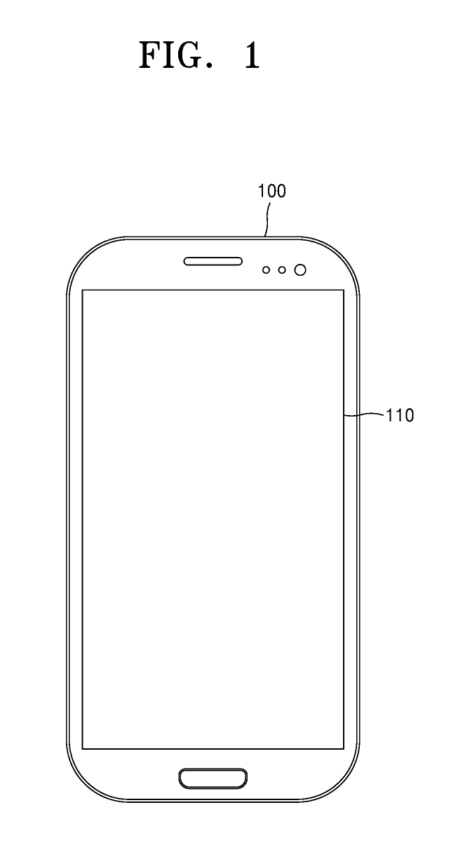

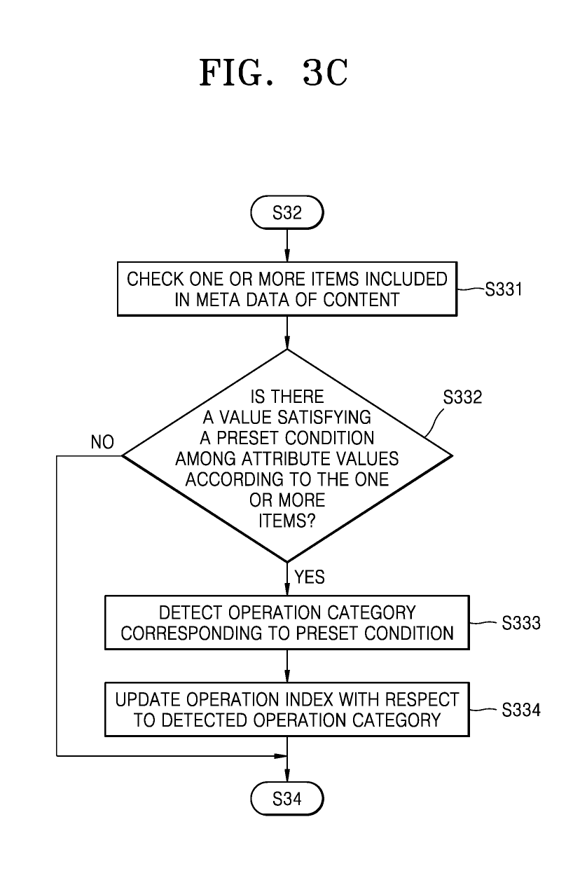

FIGS. 1 to 3D illustrate a case in which a content providing method is performed on a user terminal, according to a first example embodiment of the present disclosure. Furthermore, FIGS. 4 to 6 illustrate a content providing device provided in a server, according to a second example embodiment of the present disclosure.

### First Example Embodiment

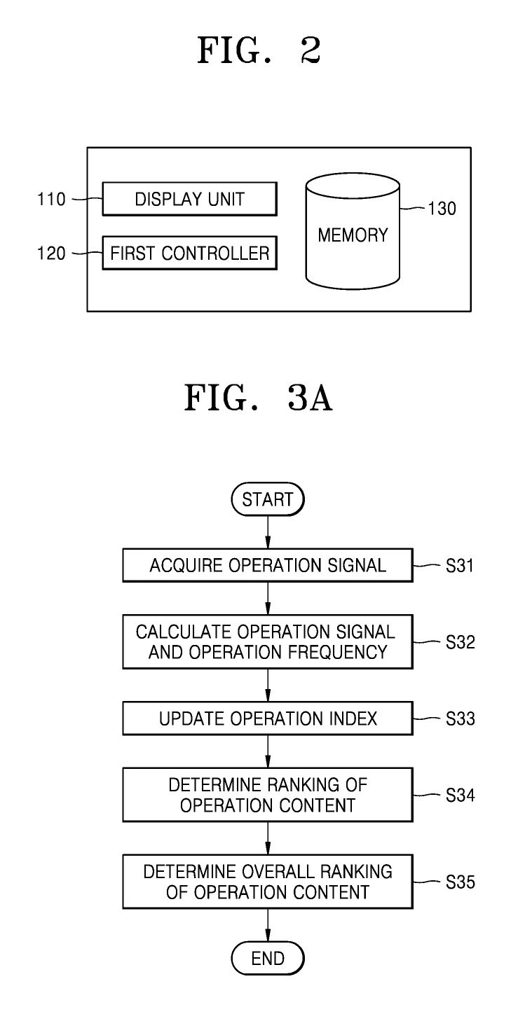

FIGS. 1 and 2 illustrate a configuration of a user terminal according to an example embodiment.

A user terminal 100 may be a personal computer (PC) or a portable terminal. Although in FIG. 1 the user terminal 100 that is a portable terminal is illustrated as a smart phone having a display unit 110, inventive concepts of the present disclosure are not limited thereto.

Referring to FIG. 2, the user terminal 100 according to the present example embodiment may include the display unit 110, a first controller 120, and a memory 130.

The display unit 110 according to an example embodiment may denote a display device for displaying figures, characters, or a combination thereof according to an electric signal generated by the first controller 120. For example, the display unit 110 may include any one of a cathode ray tube (CRT), a liquid crystal display (LCD), a plasma display panel (PDP), or an organic light-emitting diode (OLED). However, the inventive concepts of the present disclosure are not limited thereto.

The display unit 110 may further include an input unit for obtaining a user's input. For example, the display unit 110 may further include a digitizer that detects a user's touch coordinate and converts the coordinate to an electric signal, thereby obtaining a user's input according to a screen displayed on a display device. Accordingly, the display unit 110 may be a touch screen having a touch panel. In this case, the touch panel may further detect not only the user's touch coordinate but also a touch pressure, and convert the same to an electric signal.

The input unit may be provided separately from the display unit 110. For example, the input unit may be any one of a keyboard, a mouse, a trackball, a microphone, or a button, which are provided separately from the display unit 110.

In the following description, the display unit 110 is described to be a touch screen, which is capable of detecting the existence of a user's touch and a touch pressure. However, inventive concepts of the present disclosure are not limited thereto.

In the present disclosure, content may be an intangible object generated from a character, a symbol, voice, sound, an image, and/or a video using a digital method. Accordingly, content may be an object stored in the memory 130 in the form of a computer-readable file. Although in the present disclosure a photo is described as an example of content, inventive concepts of the present disclosure are not limited thereto.

The first controller 120 according to an example embodiment may include a device (e.g., processor) capable of processing data. The “processor” may denote, for example, a hardware embedded data processing device, which includes a physically structured circuit and is configured to perform functions represented by codes or commands included in a program. examples of the hardware embedded data processing device may include microprocessors, central processing units (CPUs), processor cores, multiprocessors, application-specific integrated circuits (ASICs), or field programmable gate arrays (FPGAs). However, hardware embedded data processing devices according to inventive concepts of the present disclosure are not limited thereto.

The memory 130 according to an example embodiment may temporarily or permanently store data, instructions, programs, program codes, or a combination thereof, which are processed by the user terminal 100. Furthermore, the memory 130 may temporarily or permanently store content generated by a user and/or content received from other user terminal. The memory 130 may include magnetic storage media or flash storage media. However, memories according to inventive concepts of the present disclosure are not limited thereto.

Although not illustrated in the drawings, the user terminal 100 according to the present example embodiment may include a communication unit. The communication unit may be a device including hardware and software and configured to transmit or receive a signal such as a control signal or a data signal through a wired or wireless connection with other network device. However, communication units according to inventive concepts of the present disclosure are not limited thereto.

The first controller 120 according to an example embodiment may obtain an operation signal corresponding to a user's operation with respect to operation content.

In the present disclosure, the “user's operation” may be a set of inputs input by a user to the display unit 110 to perform an operation for a specific (or alternatively, certain or a desired) purpose. For example when a user wants to perform an operation of appreciating a specific content, the user's operation may be a set of inputs such as touches, multi-touches, or drags, which are performed on the display unit 110 to search for an application for managing content, execute the application, search the application for content to be appreciated, and display the content on the display unit 110.

In the present disclosure, the “operation signal corresponding to an operation” may denote, as described above, an electrical signal that is generated by electrically converting a user's input action performed on the display unit 110. For example, when a user touches any one of a plurality of pieces of content displayed on the display unit 110 to see the content by magnifying the same, the operation signal may be an electric signal corresponding to a “touch” that is a user's operation.

In the present disclosure, the operation content may denote content that is subject to a user's operation. For example, when a user performs operations such as touching, dragging, and inputting an object to share, to share a photo B, operation content corresponding to these operations may be the photo B. Accordingly, in the present disclosure, the operation content may be content that is subject to a user's operation regardless of the type of an operation.

The first controller 120 according to an example embodiment may calculate at least one of an operation time that is the time spent for performing an operation according to an operation signal or an operation frequency corresponding to the operation signal.

In the present disclosure, a “time spent for performing an operation”, that is, the operation time, may refer to a time spent from the start of a calculation according to an operation by the first controller 120 until the calculation ends. For example, when a user performs operations such as touching, dragging, and inputting an object to share in order to share the photo B, the spent time may be time spent from the start of a series of operations by the first controller 120 until the end of the operations. The operations may include loading the photo B from the memory 130 and displaying the photo B on the display unit 110, checking identification information corresponding to the input object to share, and transmitting data of the photo B as checked identification information. This is a mere example, and the operation time may be set differently according to other standards.

In the present disclosure, the “operation frequency corresponding to an operation signal” may refer to the frequency of operations performed according to the operation signal. As described above, since the “user's operation” may be a set of inputs input by a user to perform an operation for a certain or specific purpose, the operation frequency may refer to a frequency of the user's operation including the set of inputs involving one user operation (e.g., target operation). For example, when a user performs a set of inputs such as touching, dragging, and inputting an object to share in order to share photo B, the user's operation may be to share photo B, and the first controller 120 may calculate the operation frequency corresponding to the above operation (e.g., the user operation of sharing photo B) to be “1”.

The first controller 120 may update an operation index of operation content with respect to an operation category corresponding to the operation, based on at least one of the operation time or the operation frequency.

In the present disclosure, an “operation index” of certain content may refer to a frequency of use considering the operation time and/or the operation frequency of the content. For example, the operation index may be generated and/or updated based on the operation time of the content or the operation frequency of the content. A relatively high operation index may refer to a case in which the user uses much time for operation of the content or performs many operations on the content. The operation index may be used to determine the ranking of operation content, and the ranking determination is described in detail below.

In the present disclosure, the “operation category” may refer to a category of each of the user's operations classified according to a certain standard. For example, when the user's operations may be classified into various operation categories based on the “operation” that is a target of the operation. For example, there may be an “editing category”, an “appreciation category”, and a “sharing category”. However, this is a mere example, and thus operation categories may differ according to a certain standard.

Accordingly, the first controller 120 may update relevance with respect to a specific operation category of the content, based on the operation time according to user's operation or the frequency of operation that is a target of the user's operation. For example, when a user performs several times an operation such as touching, dragging, and inputting an object to share in order to share the photo B, the operation index of the photo B with respect to the “sharing category” may increase, and this may mean that relevance of the photo B and the sharing operation is relatively large.

The user's operation may relates to a plurality of operation categories. In this case, the operation index may be set to each of the operation categories. For example, for a certain photo B, an operation index corresponding to each of the “editing category”, the “appreciation category”, and the “sharing category” may be set.

The first controller 120 according to an example embodiment may update the operation index by further considering relevance to each of a plurality of operation categories of operation content, in addition to the above-described operation time and operation frequency. The relevance may be determined by various methods. For example, the first controller 120 may determine relevance based on whether at least one attribute value of metadata of the operation content satisfies a desired (or alternatively, preset) condition. For example, when the ISO of a photo included in the metadata is greater than or equal to 1600, the first controller 120 may determine that the photo has relatively high relevance to the “editing category”. Furthermore, when a creation place is a specific place, for example, a park, the first controller 120 may determine that the photo has relatively high relevance to the “sharing category”, by referring to information about a creation place of operation content included in the metadata of the operation content.

As such, the present disclosure may update the operation index considering an individual feature of each content, and thus may provide content according to the ranking considering the individual feature of each content.

The first controller 120 according to an example embodiment may determine a ranking of operation content with respect to an operation category, based on the above-described operation index.

In the present disclosure, the ranking with respect to the operation category may be used as a content providing priority order, based on the category. Accordingly, when a plurality of pieces of content are displayed and/or provided according to a degree of relevance of the category, content having a higher ranking may be displayed and/or provided with a higher priority order.

For example, the first controller 120 according to an example embodiment may set any one of a plurality of operation categories to be a reference category, and determine display orders of one or more pieces of content according to rankings by referring to the ranking of the content with respect to the reference category.

In this case, the reference category may be set according to a user's input. For example, when a user selects, from setting items of an album application, the “appreciation category” as a sorting reference corresponding to sorting, the first controller 120 may set the appreciation category to be a reference category, and determine display orders by referring to the rankings of one or more pieces of content according to the appreciation category.

Unlike the above, the reference category may be automatically set according to a user's current operation. For example, when a user presses an “add photo” button to share a photo with other users on a messenger application, the first controller 120 may automatically set a “sharing category” as a reference category, and determine a photo having a higher operation index in the “sharing category” to be displayed on the first page or at the top side.

Furthermore, when a user executes an album application to appreciate photos on the album application, the first controller 120 may automatically set an “appreciation category” as a reference category and determine a photo having a higher operation index in the “appreciation category” to be displayed on the first page or at the top side.

As such, the first controller 120 may identify a category of a user's current operation, and provide content according to a degree of relevance to the category in providing content. However, this is a mere example, and the inventive concepts of the present disclosure are not limited thereto.

The first controller 120 may identify the category of a user's current operation, and further provide content having a relatively high similarity to the content that has the highest degree of relevance to the category of a current operation), in addition to the content having the highest degree of relevance to the category.

A relatively high similarity between content A and content B may mean that a difference in at least one attribute value of the metadata between the content A and the content B is within a desired (or alternatively, preset) range.

For example, the first controller 120 may further provide content having a photographing position within a distance of 50 m from a photographing position of content having the highest degree of relevance to the category of a current operation, by referring to a geotag item of the metadata. Furthermore, the first controller 120 may further provide content having a photographing time within an interval of 10 min from a photographing time of content having the highest degree of relevance to the category of a current operation, or content photographed on the same date one year ago from the photographing time of the content having the highest degree of relevance to the category of a current operation. However, this is a mere example, and the inventive concepts of the present disclosure are not limited thereto. Various modifications are possible according to the type of an item included in the metadata of content.

The first controller 120 according to an example embodiment may display one or more pieces of content on the display unit 110 according to the determined display order.

The first controller 120 according to an example embodiment may determine an overall ranking of operation content, based on an operation index with respect to each of a plurality of operation categories of operation content.

In the present disclosure, the “overall ranking” (also referred to as overall ranking of content), which is a ranking different from the above-described “ranking with respect to the operation category”, may refer to a priority order based on at least one operation index of certain content.

For example, when an operation index exists for each of the “editing category”, the “appreciation category”, and the “sharing category” with respect to certain content, the first controller 120 may determine the overall ranking of the content based on a sum of the respective operation indexes.

In the determination of the overall ranking, the category of a user's current operation may be considered. For example, when a user executes an album application to appreciate photos, the first controller 120 may determine the overall ranking of the content according to a value obtained by multiplying an operation index of the “editing category” by 0.6, an operation index of the “appreciation category” by 0.8 that is relatively high, and an operation index of the “sharing category” by 0.3 that is relatively low, and summing the multiplied values. Thus, the first controller 120 may determine the priority order of content based on the obtained value (e.g., the overall ranking of the content).

If the obtained value is high, it may mean that a time spend to perform an operation, by a user, with respect to operation content is long. Furthermore, this may mean that a user is highly likely to perform another operation with respect to the content.

According to the related art, a plurality of pieces of content are simply displayed and/or provided according to the creation time of content or the file name of content. Accordingly, when content that a user is interested in is located in the middle of content list, the user may experience inconvenience of moving or scrolling down to the middle of the list for the operation of the content.

According to some example embodiments of the present disclosure, content providing methods may determine content to be displayed and/or providing priority order based on the user's operation time and/or operation frequency with respect to an individual content, Thus, a user may easily locate or perform operation with regard to an interested content.

Furthermore, according to some example embodiments of the present disclosure, content providing method may provide content considering the operation category of a current operation. Therefore, content more relevant to the user's need may be provided.

As such, the first controller 120 may determine the overall ranking of operation content based on a weight for each of a plurality of operation categories and an option index of each of the operation categories.

When the above-described overall ranking is lower than a first desired (or alternatively, preset) ranking, the first controller 120 may perform a first action regarding deletion, and when the overall ranking is higher than a second desired (or alternatively, preset) ranking, the first controller 120 may perform a second action regarding storage.

In this case, the first action may include at least one of displaying a message of recommending deletion of operation content or performing deletion of operation content, and the second action may include at least one of displaying a message of recommending storage of operation content or transmitting operation content.

Accordingly, the first controller 120 may prompt transmission of content having an overall ranking higher than the first desired (or alternatively, preset) ranking to anther storage device, and may actually perform transmission of the content. Further, the first controller 120 may prompt deletion of content having an overall ranking lower than the second desired (or alternatively, preset) ranking, and may actually perform deletion of the content.

Thus, the present disclosure may efficiently use a content storing space.

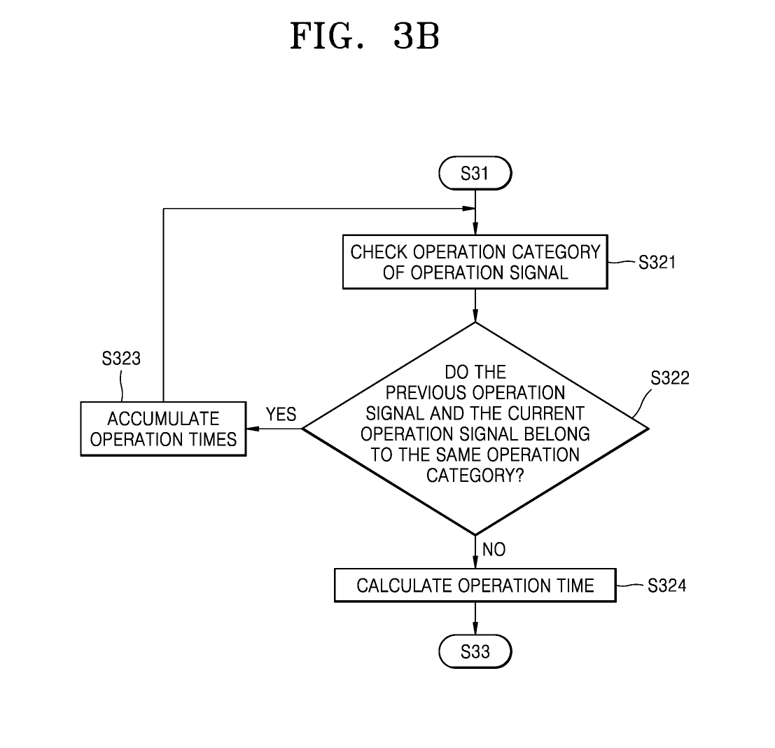

FIG. 3A to 3D are flowcharts of content providing method performed by the user terminal 100. In the following description, detailed descriptions of redundant content set forth in FIGS. 1 and 2 are omitted.

First, referring to FIG. 3A, the first controller 120 according to an example embodiment may acquire an operation signal corresponding to a user's operation with respect to operation content (S31).

In the present disclosure, the “user's operation” may be a set of inputs input by a user to the display unit 110 to perform an operation for a certain or specific purpose. In the present disclosure, the “operation signal corresponding to an operation” may refer to an electrical signal that is generated by electrically converting a user's input action performed on the display unit 110. In the present disclosure, operation content may refer to content subject to a user's operation.

The first controller 120 according to an example embodiment may calculate at least one of the operation time (e.g., the time spent for performing an operation according to an operation signal) or the operation frequency corresponding to the operation signal (S32).

In the present disclosure, the “time spent for performing an operation”, that is, the operation time, may refer to the time spent from the start of calculation according to an operation to the end of the calculation. However, this is a mere example, and the operation time may be set differently according to other standards.

In the present disclosure, the “operation frequency corresponding to an operation signal” may refer to the frequency of an operation performed according to the operation signal. As described above, since the “user's operation” may be a set of inputs input by a user to perform an operation for a certain or specific purpose, the operation frequency may refer to a frequency of the user's operation including the set of inputs involving one user operation (e.g., target operation).

The first controller 120 may update the operation index of operation content with respect to the operation category corresponding to the user operation, based on at least one of the operation time or the operation frequency (S33).

In the present disclosure, the “operation index” of certain content may refer to the frequency of use of the content. For example, in the present disclosure, the operation frequency may be generated and/or updated based on the operation time of content or the operation frequency of content. A relatively high operation index may refer to a case in which the user uses much time for operation of the content or performs many operations on the content.

In the present disclosure, the “operation category” may refer to a category of each of the user's operations classified according to a certain standard. For example, when the user's operations may be classified into various operation categories (e.g., an “editing category”, an “appreciation category”, and a “sharing category”) based on the purpose of an operation.

The above-described operation category may include a plurality of operation categories, and in this case, the operation index may be set to each of a plurality of operation categories.

The first controller 120 according to an example embodiment may update the operation index by further considering relevance to each of a plurality of operation categories of operation content, in addition to the above-described operation time and operation frequency. The relevance may be determined by various methods.

As such, the present disclosure may update the operation index considering the individual feature of each content, and thus may provide content according to a ranking considering the individual feature of each content.

The first controller 120 according to an example embodiment may determine the ranking of operation content with respect to an operation category, based on the above-described operation index (S34).

For example, the first controller 120 according to an example embodiment may set any one of a plurality of operation categories to be a reference category, and determine display orders of one or more pieces of content according to rankings by referring to the rankings of the one or more pieces of content with respect to the reference category.

In this case, the reference category may be set according to a user's input. In contrast, the reference category may be automatically set according to the user's current operation.

The first controller 120 according to an example embodiment may determine the overall ranking of operation content, based on the operation index of each of a plurality of operation categories of operation content (S35). In the present disclosure, the “overall ranking”, which is different from the above-described “ranking with respect to the operation category”, may be used as a priority order based on at least one operation index of certain content.

FIG. 3B is a flowchart of a process in which the first controller 120 according to an example embodiment calculates a time spent for performing an operation according to an operation signal.

Referring to FIG. 3B, the first controller 120 may check the operation category of an operation signal (S321). For example, the first controller 120 may check the operation category of an operation signal to be the “editing category”, or the “appreciation category”.

Then, the first controller 120 may determine whether the operation category of a previous operation signal and the operation category of a current operation signal are identical to each other (S322), In this case, the previous operation signal may be an operation signal obtained before the current operation signal is obtained.

The first controller 120 may accumulate the operation times when the operation category of a current operation signal and the operation category of a previous operation signal are identical to each other (S323), and calculate the operation times when the operation category of a current operation signal and the operation category of a previous operation signal are different from each other (S324). In this case, the first controller 120 may calculate, as the “operation time”, the operation times accumulated according to the operation signal that is continuous with the previous operation signal and belongs to the same operation category as the operation category of the previous operation signal. The calculated operation time may be used when the first controller 120 updates the operation index as described above.

FIG. 3C is a flowchart of a process in which the first controller 120 according to an example embodiment updates the operation index by further considering the relevance to each of a plurality of operation categories of operation content, in addition to the operation time and the operation frequency.

Referring to FIG. 3C, the first controller 120 may check one or more items included in the metadata of content (S331). In this case, the one or more items may include the field name of each attribute value.

Then, the first controller 120 may check whether there is a value satisfying a desired (or alternatively, preset) condition among the attribute values included in the above-described one or more items (S332). The desired (or alternatively, preset) condition may be set in various ways. For example, the desired (or alternatively, preset) condition may be a condition about a creation time or a creation location of each content, or a shutter speed or sensitivity of a photo.

When there is a value satisfying the desired (or alternatively, preset) condition among the attribute values included in the one or more items, the first controller 120 may detect an operation category corresponding to the desired (or alternatively, preset) condition (S333). In other words, the first controller 120 may check whether the metadata of content satisfies the desired (or alternatively, preset) condition, and if so, the controller 120 may detect an operation category corresponding to the condition.

Next, the first controller 120 may update an operation index of operation content with respect to the detected operation category (S334). Accordingly, the first controller 120 may determine the ranking of the operation content considering the relevance with respect to the operation category of the operation content.

FIG. 3D is a flowchart of a process in which the first controller 120 according to an example embodiment determines the ranking of operation content with respect to an operation category based on the operation index.

Referring to FIG. 3D, the first controller 120 may check the operation indexes of a plurality of pieces of content with respect to the operation category (S341). For example, the first controller 120 may check the operation indexes with respect to the operation category of one hundred (100) content by checking the metadata of the 100 content.

Next, the first controller 120 may determine the ranking of the operation content by comparing the operation indexes of a plurality of pieces of content with the operation index of the operation content (S342). Accordingly, the first controller 120 may determine the ranking of the operation content among a plurality of pieces of content.

### Second Example Embodiment

FIGS. 4 to 6 illustrate a content providing device according to a second example embodiment of the present disclosure. In the above-described first embodiment, the user terminal 100 performs a series of processes for providing content. However, in the present embodiment, a process of providing the ranking of content to a user terminal is performed on a server that is connected to the user terminal via a network.

FIG. 4 illustrates a configuration of content providing system according to an example embodiment.

Referring to FIG. 4, a content providing system according to an example embodiment may include a communication network 400 that connects a server 200 with a user terminal 300.

The content providing system according to an example embodiment may provide the user terminal 300 with a content providing program or a content providing website. In the content providing system according to an example embodiment, the server 200 may receive a user's operation signal from the user terminal 300 and determine the ranking of content according to the received operation signal. The server 200 may transmit information about the determined ranking to the user terminal 300.

Referring to FIG. 4, the user terminal 300 may refer to a communication terminal capable of using web services in a wired/wireless communication environment. The user terminal 300 may be a personal computer 301 or a portable terminal 302. Although FIG. 4 illustrates that the portable terminal 302 as a smart phone, inventive concepts of the present disclosure is not limited thereto, and a terminal mounted with an application capable of web browsing as described above may be used without limitation.

The user terminal 300 may include, like the user terminal 100 of the first example embodiment, a display unit used as both of a display device and an input device, a controller, and a communication unit.

The communication network 400 connects the server 200 with the user terminal 300. For example, the communication network 400 provides an access path to transmit or receive packet data after accessing the server 200 and the user terminal 300. The communication network 400 may include a wired network, for example, local area networks (LANs), wide area networks (WANs), metropolitan area networks (MANs), or integrated service digital networks (ISDNs), or a wireless network, for example, wireless LANs, CDMA, Bluetooth, or satellite communication, but the scope of the present disclosure is not limited thereto.

The server 200 provides the user terminal 300 with a webpage for providing a content providing program and/or a content providing service. For example, the server 200 may receive information about an operation from the user terminal 300 through the web page for providing a content providing program or a content providing service, and determine the ranking of content according to the received information about the operation.

Although not illustrated in the drawings, the server 200 according to an example embodiment may include a memory, an input/output unit, and a communication unit. The memory performs a function to temporarily or permanently store data, instructions, programs, program codes, or a combination thereof, which are processed by the server 200. The memory may include a magnetic storage media or a flash storage media, but example embodiments of the present disclosure are not limited thereto. The communication unit may be a device including hardware and software configured to transmit and receive a signal such as a control signal or a data signal through a wired/wireless connection to another network device. The controller may include all types of devices capable of processing data like a processor. The “processor” may signify, for example, a hardware embedded data processing device including a physically structured circuit to perform a function represented by codes or instructions included in a program. As such, an example of the hardware embedded data processing device may include, for example, a microprocessor, a central processing unit (CPU), a processor core, a multiprocessor, an application-specific integrated circuit (ASIC), or a field programmable gate array (FPGA), but example embodiments of the present disclosure are not limited thereto.

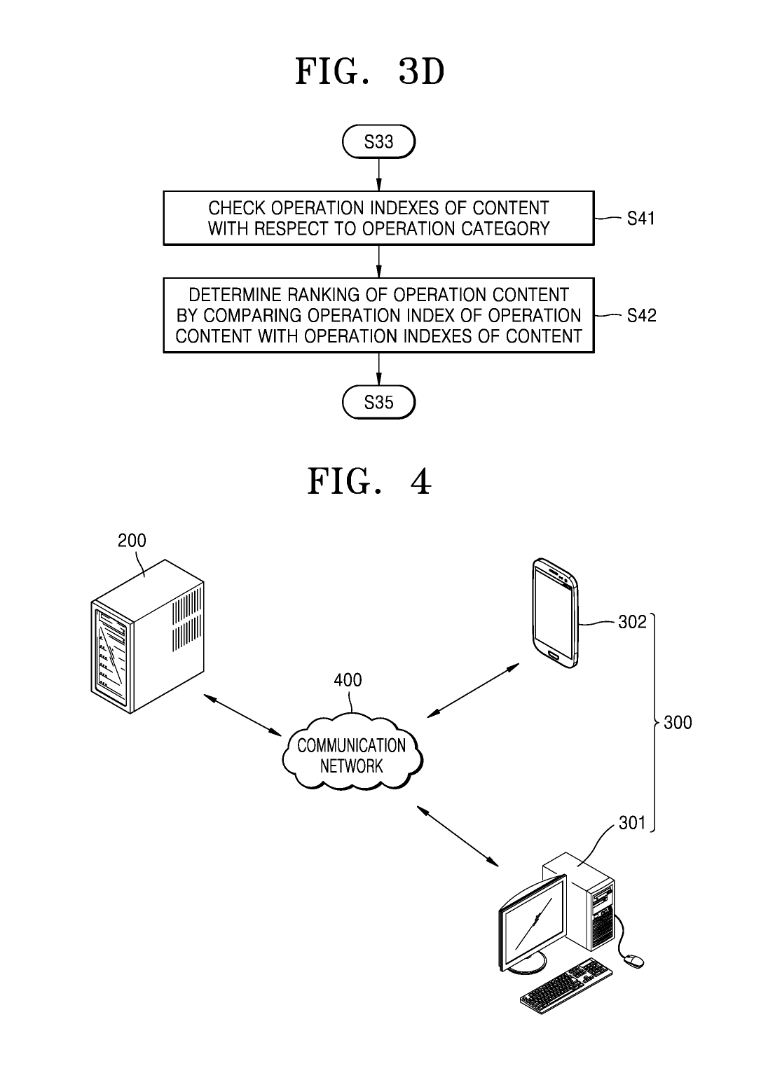

FIG. 5 is a block diagram of a configuration of content providing device 210 provided in the server 200 of FIG. 4, according to an example embodiment.

The content providing device 210 according to an example embodiment may correspond to at least one processor or may include at least one processor. Accordingly, the content providing device 210 may be driven in a form included in another hardware device such as a microprocessor or a general purpose computer system. Although FIG. 5 illustrates that the content providing device 210 is provided in the server 200, example embodiments of the present disclosure are not limited thereto, and the content providing device 210 may be provided in the user terminal 300 according to a design modification.

The content providing device 210 according to an example embodiment may include a communication unit 211, a second controller 212, and a database 213.

The communication unit 211 according to an example embodiment may receive an operation signal corresponding to a user's operation with respect to operation content, from the user terminal 300.

In the above-described first example embodiment, a series of operation signals corresponding to the user's operation is “acquired” from the user terminal 100. In the present example embodiment, the communication unit 211 “receives” the operation signal that the user terminal 300 acquires and transmits.

In the present example embodiment, the “user's operation”, the “operation signal”, and the “operation content” are used to have the same meaning used in the above-described example embodiment. Thus, detailed descriptions thereof are omitted.

The second controller 212 according to an example embodiment may calculate at least one of the time spent for performing an operation according to an operation signal or the operation frequency corresponding to the operation signal that the communication unit 211 received.

In this case, since the “time spent for performing an operation” and the “operation frequency corresponding to an operation signal” are used to have the same meaning used in the above-described embodiment, detailed descriptions thereof are omitted.

The second controller 212 according to an example embodiment may update the operation index with respect to the operation category corresponding to the operation of operation content, based on at least one of the operation time or the operation frequency.

In this case, since the “operation index” and the “operation category” are used to have the same meaning used in the above-described embodiment, detailed descriptions thereof are omitted.

The second controller 212 may update relevance with respect to a specific operation category of the content, based on the operation time according to the user's operation or the frequency of an operation that is the purpose (or target) of the user's operation. For example, when a user performs several times an operation such as touching, dragging, and inputting an object to share in order to share the photo B, the operation index of the photo B with respect to the “sharing category” may increase, and this may mean that relevance between the photo B and the sharing operation is relatively large.

The user's operation may relate to a plurality of operation categories. In this case, the operation index may be set for each operation category. For example, an operation index corresponding to each of the “editing category”, the “appreciation category”, and the “sharing category” may be set with respect to a certain photo B.

The second controller 212 according to the present example embodiment may also update the operation index by further considering the relevance to each of a plurality of operation categories of operation content, in addition to the above-described operation time and the operation frequency.

In this case, the content and/or metadata of content that is the basis of the relevance may be received by the communication unit 211 from the user terminal 300.

Since the method of determining the relevance by the second controller 212 is the same as that according to the above-described first example embodiment, a detailed description thereof is omitted.

As such, the present disclosure may update the operation index by considering the individual feature of each content, and thus content may be provided according to the ranking considering the individual feature of each content.

The second controller 212 according to an example embodiment may determine the ranking of operation content with respect to an operation category, based on the above-described operation index.

In the present disclosure, the ranking with respect to the operation category may be used as a priority order to provide content based on the category. Accordingly, when a plurality of pieces of content are displayed and/or provided according to a degree of relevance of the category, content may be displayed and/or provided in a priority order according to the ranking of the content.

For example, the second controller 212 according to the present example embodiment may set any one of a plurality of operation categories to be a reference category, and determine display orders of one or more pieces of content according to rankings by referring to the rankings of the one or more pieces of content with respect to the reference category.

In this case, the reference category may be set according to the user's input that the communication unit 211 receives from the user terminal 300. Furthermore, the reference category may be automatically set according to the user's current operation.

The second controller 212 according to an example embodiment may determine the overall ranking of operation content, based on the operation index with respect to each of a plurality of operation categories of operation content.

In the present disclosure, the “overall ranking”, which is a different from the above-described “ranking with respect to the operation category”, may be used as a priority order based on at least one index of certain content. For example, when the operation index for each of the “editing category”, the “appreciation category”, and the “sharing category” exists for certain content, the first controller 120 may determine an overall ranking of the content based on a sum of the respective operation indexes.

The second controller 212 may determine the overall ranking of operation content based on the weight with respect to each of a plurality of operation categories and the operation index with respect to each of a plurality of operation categories.

For example, when a user executes an album application to appreciate photos, the second controller 212 may determine an overall ranking of content according to a value obtained by multiplying an operation index of the “editing category” by 0.6, an operation index of the “appreciation category” by 0.8 that is relatively high, and an operation index of the “sharing category” by 0.3 that is relatively low, and summing the multiplied values. Even in this case, the second controller 212 may determine a priority order of content based on the obtained value (e.g., the overall ranking of the content).

When the above-described overall ranking is lower than a desired (or alternatively, preset) ranking, the second controller 212 according to an example embodiment may perform a first action regarding deletion, and when the overall ranking is higher than a second desired (or alternatively, preset) ranking, the second controller 212 according to an example embodiment may perform a second action regarding storage.

In this case, the first action may be at least one of transmitting a message of recommending deletion of operation content or performing deletion of operation content, and the second action may be at least one of transmitting a message of recommending storage of an operation or receiving operation content.

Accordingly, the second controller 212 may prompt transmission of content having an overall ranking higher than the first desired (or alternatively, preset) ranking to another storage device, and actually transmit the content, and may prompt deletion of content having an overall ranking lower than the second desired (or alternatively, preset) ranking, and actually delete the content.

Thus, according to the present disclosure, the content storing space may be efficiently used.

The communication unit 211 may transmit information about at least one of the determined ranking or overall ranking to the user terminal 300.

The user terminal 300 may receive information about at least one of the ranking and the overall ranking, or display and/or provide content according to the ranking.

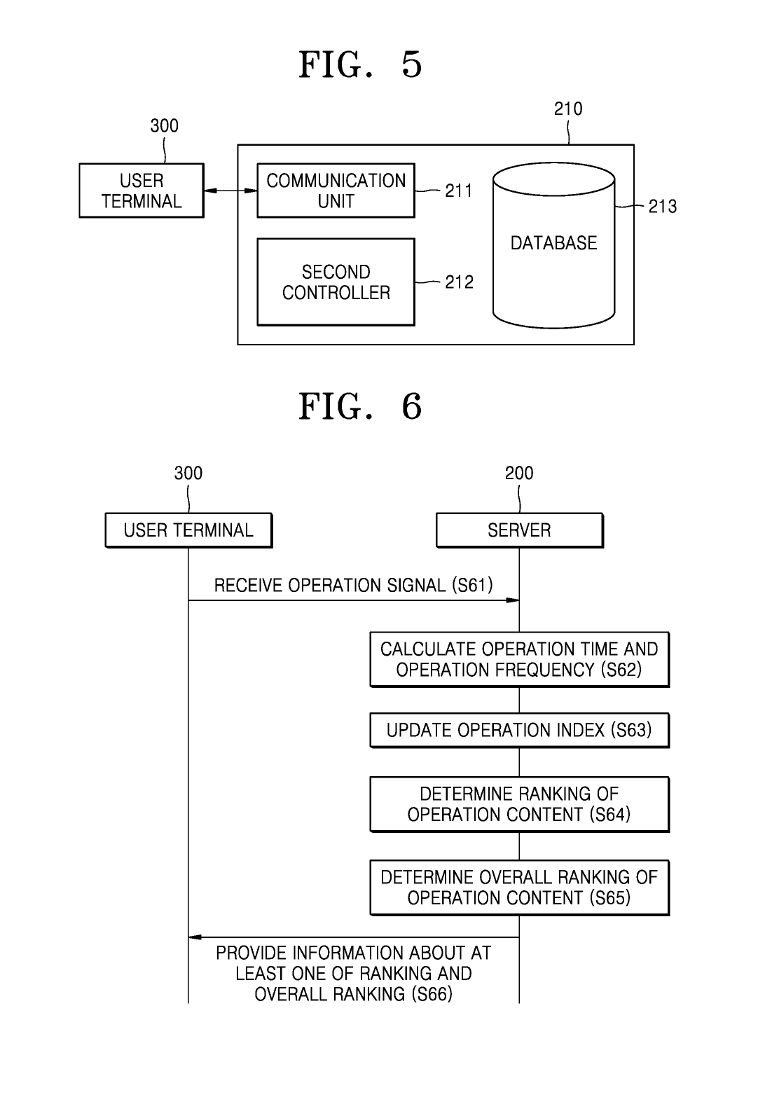

FIG. 6 is a flowchart of a method of processing information between the server 200 and the user terminal 300, according to an example embodiment. Since the server 200 of FIG. 6 may include the content providing device 210 of FIG. 5, the description about the content providing device 210 of FIG. 5 may be applied to FIG. 6 even when the description is omitted in the following description.

The server 200 according to an example embodiment may receive from the user terminal 300 an operation signal corresponding to a user's operation with respect to operation content (S61).

In the above-described first example embodiment, the user terminal 100 “acquires” a series of operation signals corresponding to a user's operation, and in the present example embodiment, the server 200 “receives” the operation signal that the user terminal 300 acquires and transmits.

In the present embodiment, since the “user's operation”, the “operation signal”, and the “operation content” are used to have the same meanings as those in the above-described example embodiment, detailed descriptions thereof are omitted.

The server 200 according to an example embodiment may calculate at least one of the time spent for performing an operation according to an operation signal or the operation frequency corresponding to the operation signal, which are received by the communication unit 211 (S62). In this case, since the “time spent for performing an operation” and the “operation frequency corresponding to an operation signal” are used to have the same meanings as those in the above-described example embodiment, detailed descriptions thereof are omitted.

The server 200 according to an example embodiment may update the operation index with respect to the operation category corresponding to the operation of the operation content, based on at least one of the operation time or the operation frequency (S63). In this case, since the “operation index” and the “operation category” are used to have the same meanings in those in the above-described example embodiment, detailed descriptions thereof are omitted. As such, the server 200 may update relevance with respect to a specific operation category of the content, based on the operation time according to the user's operation or the frequency of an operation that is the purpose of the user's operation.

The server 200 according to an example embodiment may determine the ranking of operation content with respect to an operation category, based on the above-described operation index (S64). In the present disclosure, the ranking with respect to the operation category may have a meaning as a priority order to provide content with respect to the category. Accordingly, when a plurality of pieces of content are displayed and/or provided according to a degree of relevance of the category, content having a higher ranking may be displayed and/or provided in a higher priority order.

For example, the server 200 according to the present example embodiment may set any one of a plurality of operation categories to be a reference category, and determine display orders of one or more pieces of content according to rankings by referring to the rankings of the one or more pieces of content with respect to the reference category.

In this case, the reference category may be set according to the user's input that the communication unit 211 receives from the user terminal 300. Furthermore, the reference category may be automatically set according to the user's current operation.

The second controller 212 according to an example embodiment may determine the overall ranking of operation content based on the operation index with respect to each of a plurality of operation categories of operation content (S65). in the present disclosure, the “overall ranking”, which is different from the above-described “ranking with respect to the operation category”, may have a meaning as a priority order based on at least one index of certain content. For example, when the operation index for each of the “editing category”, the “appreciation category”, and the “sharing category” exists for certain content, the first controller 120 may determine an overall ranking of the content based on a sum of the respective operation indexes.

The server 200 may determine the overall ranking of operation content based on the weight with respect to each of a plurality of operation categories and the operation index with respect to each of a plurality of operation categories. For example, when the user executes an album application to appreciate photos, the server 200 may determine the overall ranking of content according to a value obtained by multiplying an operation index of the “editing category” by 0.6, an operation index of the “appreciation category” by 0.8, and an operation index of the “sharing category” by 0.3, and summing the multiplied values. In this case, the server 200 may determine the priority order of content based on the obtained value (e.g., the overall ranking of the content).

When the above-described overall ranking is lower than a first desired (or alternatively, preset) ranking, the server 200 according to an example embodiment may perform a first action regarding deletion, and when the overall ranking is higher than a second desired (or alternatively, preset) ranking, the server 200 may perform a second action regarding storage.

In this case, the first action may be at least one of transmitting a message of recommending deletion of operation content or performing deletion of operation content, and the second action may be at least one of transmitting a message of recommending storage of operation content or receiving operation content.

Accordingly, the server 200 may prompt transmission of content having an overall ranking higher than the first desired (or alternatively, preset) ranking to another storage device, and actually transmit the content, and may prompt deletion of content having an overall ranking lower than the second desired (or alternatively, preset) ranking, and actually delete the content.

Thus, according to the present disclosure, the content storing space may be efficiently used.

The communication unit 211 may transmit information about at least one of the determined ranking or overall ranking to the user terminal 300 (S66).

The user terminal 300 may receive the information about at least one of the ranking or overall ranking, and may display and/or provide content according to the ranking.

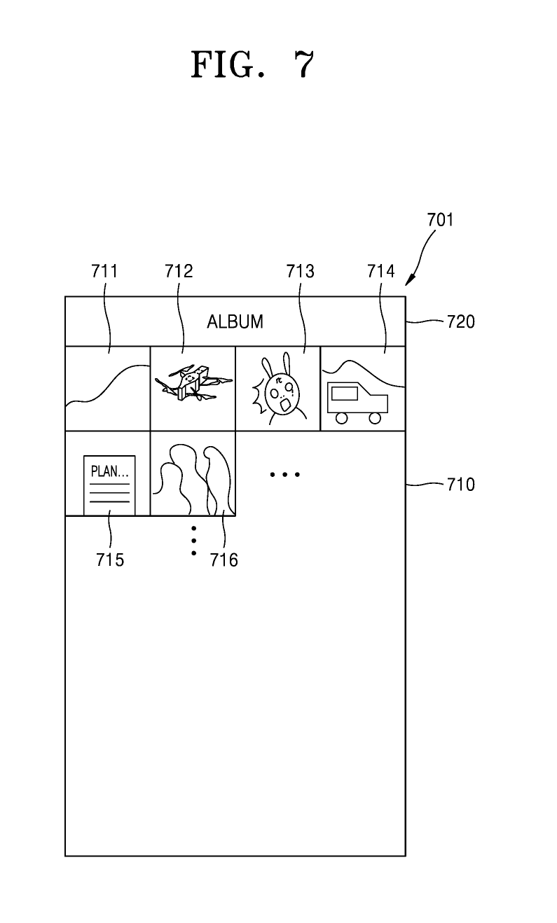

FIGS. 7 to 10 illustrate screens displayed on the user terminals 100 and 300, according to some example embodiments.

FIG. 7 illustrates a screen 701 showing content displayed on a display of the user terminals 100 and 300, according to an example embodiment of the present disclosure.

Referring to FIG. 7, the screen 701 may include a content display area 710 where one or more pieces of content 711 to 716 are displayed and a title display area 720 where a title is displayed.

For example, it is assumed that the order of content is 715-713-712-716-711-714 according to a sorting standard by which content having a later creation time is located more forward, and the order of content is 711-712-713-714-715-716 according to a sorting standard by which content having a higher ranking according to the appreciation category is located more forward.

Thus, the content arranged in the original order of 715-713-712-716-711-714 is rearranged according to the ranking according to the appreciation category such that that content 715 is located at a position of content 711, content 713 is located at a position of content 712, content 712 is located at a position of content 713, content 716 is located at a position of content 714, content 711 is located at a position of content 715, and content 714 is located at a position of content 716.

Accordingly, content having a higher ranking is located more forward in the content display area 710, so that a user may more quickly select content.

FIG. 7 is an example of a case in which a user executes an album application to appreciate photos, in which content are sorted according to the ranking with respect to the appreciation category. Accordingly, the content providing method according to the present disclosure may be used for any applications for providing content.

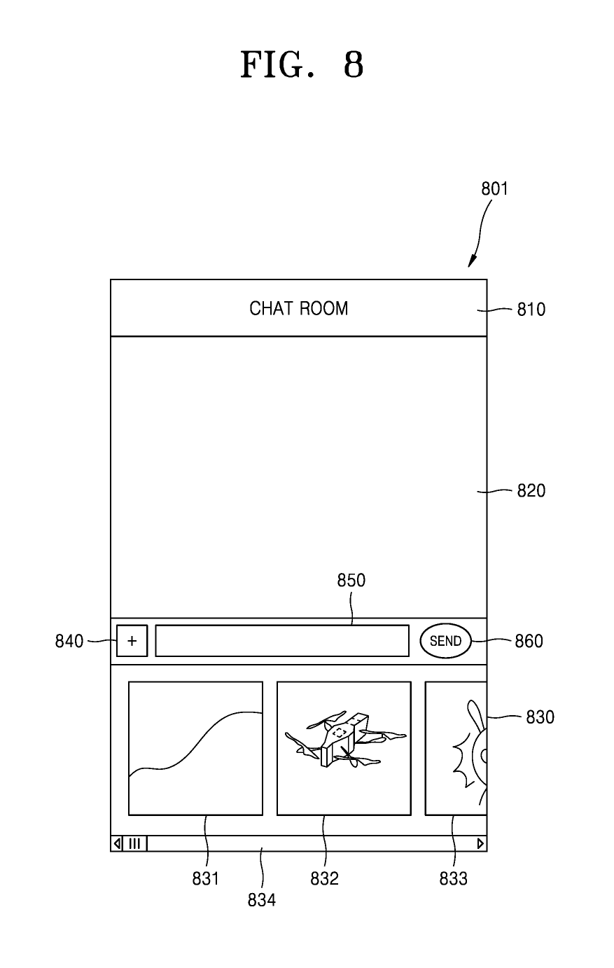

FIG. 8 illustrates a screen 801 in which the content providing method according to an example embodiment of the present disclosure is applied to a messenger application.

Referring to FIG. 8, the screen 801 may include an area 810 for displaying a title of a chat room, an area 820 for displaying a chat content, an area 830 for displaying one or more pieces of content 831 to 833 to be sent in response to a user's input through a content send button 840, a scroll bar 834, a message input window 850, and a message send button 860.

If a application is not an application for managing content or appreciations, the size of the area 830 in which a user can check a plurality of pieces of content to select one or more pieces of content may be restricted. In this case, when content are simply listed in the order of a creation time and/or an identification number and displayed for a user, the user needs to perform an additional operation to move to a location at which a desired content is located, for example, by using the scroll bar 834.

As illustrated in FIG. 8, however, according to an example embodiment of the present disclosure, as content, for example, the content 831 to 833, which have relatively high rankings for each category and/or relatively high overall rankings at a page and/or in an area that is first exposed, are displayed in the area 830 for display content, a user may easily and quickly select a desired content.

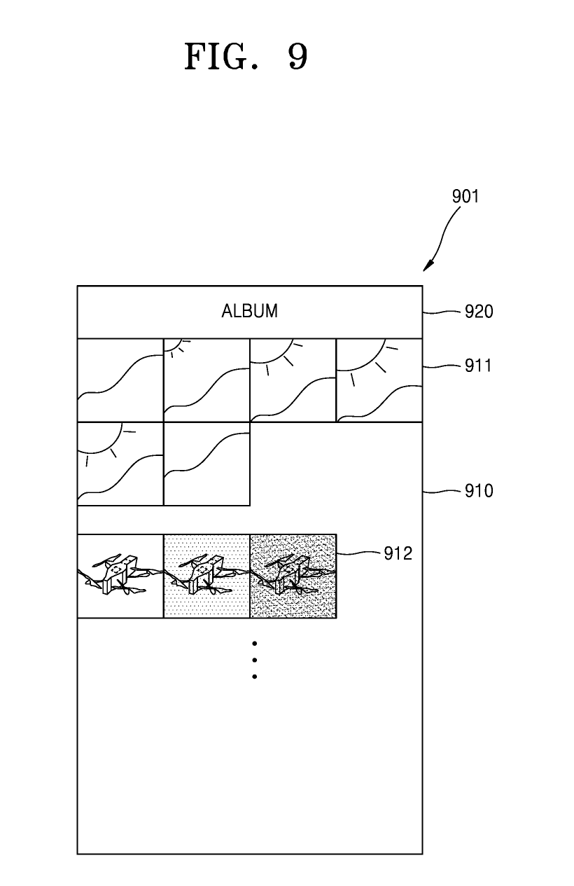

FIG. 9 illustrates a screen 901 on which one or more pieces of content are provided for each operation category on the display unit of the user terminals 100 and 200, according to an example embodiment of the present disclosure.

The screen 901 of FIG. 9 may include a content display area 910 for displaying content 911 and 912 for each category and a title display area 920 for displaying a title.

According to an example embodiment of the present embodiment, as the content 911 and 921 for each category are displayed according to the ranking in a respective category, a user may easily identify certain content having a relatively high ranking according to each category. Accordingly, according to an example embodiment of the present disclosure, content having a relatively high ranking may be quickly selected and content belonging to the same category may be easily identified.

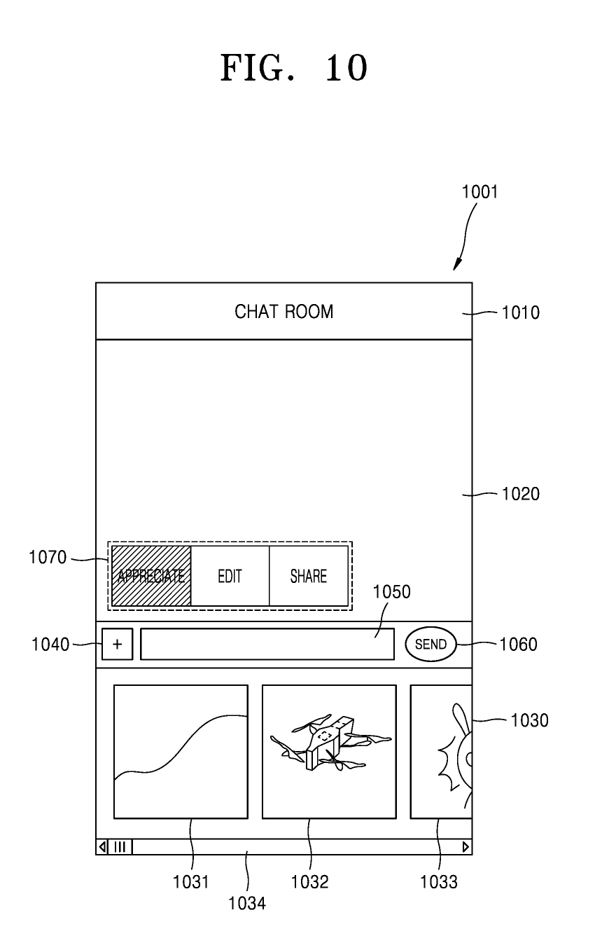

FIG. 10 illustrates a screen 1001 in which the content providing method according to an example embodiment of the present disclosure is applied to a messenger application.

Referring to FIG. 10, the screen 1001 may include an area 1010 for displaying a title of a chat room, an area 1020 for displaying a chat content, an area 1030 for displaying one or more pieces of content 1031 to 1033 to be sent in response to a user's input through a content send button 1040, a scroll bar 1034, a message input window 1050, and a message send button 1060. Furthermore, the screen 1001 may further include a sorting standard select button 1070 to select a sorting standard of content displayed in the area 1030 for displaying content.

In this case, a plurality of pieces of content 1031 to 1033 are displayed in the area 1030 for displaying content in the order of content having a relatively high ranking according to the selected sorting standard, and other content may be displayed by changing the sorting standard through the user's sorting standard select button 1070.

The above-described example embodiments according to the present disclosure may be embodied in form of a program command executable through various computing devices, and may be recorded on a computer-readable medium. The computer-readable medium may include a program command, a data file, a data structure, etc. solely or by combining the same. A program command recorded on the medium may be specially designed and configured for the present disclosure or may be a usable one, such as computer software, which is well known to one of ordinary skill in the art to which the present disclosure pertains to. A computer-readable recording medium may include magnetic media such as hard discs, floppy discs, and magnetic tapes, optical media such as CD-ROM or DVD, magneto-optical media such as floptical disks, and hardware devices such as ROM, RAM flash memory, which are specially configured to store and execute a program command. Furthermore, the medium may include intangible medium implemented to be capable of transmitting on a network. For example, the medium may be implemented in the form of software or application so as to be transmitted and distributed via a network.

The computer program may be specially designed and configured for the present disclosure or may be well-known to one skilled in the art of computer software, to be usable. An example of a computer program may include not only machine codes created by a compiler but also high-level programming language executable by a computer using an interpreter

In the present disclosure, the particular implementations shown and described herein are illustrative examples of the disclosure and are not intended to otherwise limit the scope of the disclosure in any way. For the sake of brevity, conventional electronics, control systems, software development and other functional aspects of the systems may not be described in detail. Furthermore, the connecting lines, or connectors shown in the various figures presented are intended to represent functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential” or “critical.”

It should be understood that the example embodiments described herein should be considered in a descriptive sense only and not for purposes of limitation. Descriptions of features or aspects within each example should typically be considered as available for other similar features or aspects in other example embodiments.

1. A non-transitory computer-readable recording medium storing a computer program that, when executed by a computer, causes the computer to perform a method comprising:
acquiring an operation signal with respect to operation content;
calculating, according to the operation signal, at least one of an operation time or an operation frequency corresponding to the operation signal, the operation time being time spent for performing an operation;
updating an operation index of the operation content with respect to at least one operation category corresponding to the operation, based on at least one of the operation time or the operation frequency; and
determining a ranking of the operation content with respect to the at least one operation category, based on the operation index.

2. The non-transitory computer-readable recording medium of claim 1, wherein the at least one operation category comprises a plurality of operation categories, and the operation index is set for each of the plurality of operation categories.

3. The non-transitory computer-readable recording medium of claim 2, wherein the method further comprises:
setting any one of the plurality of operation categories as a reference category;
determining a display order of one or more pieces of content according to rankings of the one or more pieces of content with respect to the reference category; and
displaying the one or more pieces of content according to the display order.

4. The non-transitory computer-readable recording medium of claim 1, wherein the at least one operation category comprises any one of an operation category for appreciating the operation content, an operation category for editing, an operation category for sharing, or an operation category for setting a favorite.

5. The non-transitory computer-readable recording medium of claim 2, wherein the method further comprises determining an overall ranking of the operation content based on the operation index of the operation content with respect to each of the plurality of operation categories.

6. The non-transitory computer-readable recording medium of claim 5, wherein the determining an overall ranking includes determining the overall ranking based on a weight with respect to each of the plurality of operation categories and the operation index with respect to each of the plurality of operation categories.

7. The non-transitory computer-readable recording medium of claim 6, wherein the method further comprises:
performing a first action regarding deletion in response to the overall ranking being lower than a first threshold ranking,
performing a second action regarding storage in response to the overall ranking being higher than a second threshold ranking,
wherein the first action includes at least one of displaying a message of recommending deletion of the operation content or performing deletion of the operation content, and
the second action includes at least one of displaying a message of recommending storage of the operation content or transmitting the operation content.

8. The non-transitory computer-readable recording medium of claim 2, wherein the updating includes updating the operation index by further considering relevance of the operation content with respect to each of the plurality of operation categories, in addition to at least one of the operation time or the operation frequency.

9. The non-transitory computer-readable recording medium of claim 8, wherein the relevance is determined based on whether at least one attribute value of metadata of the operation content satisfies a condition.

10. A content providing method comprising:
acquiring an operation signal with respect to operation content;
calculating, according to the operation signal, at least one of an operation time or an operation frequency corresponding to the operation signal, the operation time being time spent for performing an operation;
updating an operation index of the operation content with respect to at least one operation category corresponding to the operation, based on at least one of the operation time or the operation frequency; and
determining a ranking of the operation content with respect to the at least one operation category, based on the operation index.

11. The content providing method of claim 10, wherein the at least one operation category comprises a plurality of operation categories, and
the operation index is set for each of the plurality of operation categories.

12. The content providing method of claim 11, further comprising:
setting any one of the plurality of operation categories as a reference category;
determining a display order of one or more pieces of content according to the ranking, by referring to the ranking of the one or more pieces of content with respect to the reference category; and
displaying the one or more pieces of content according to the display order.

13. The content providing method of claim 11, further comprising:
determining an overall ranking of the operation content based on the operation index of the operation content with respect to each of the plurality of operation categories.

14. The content providing method of claim 13, wherein the determining an overall ranking includes determining the overall ranking based on a weight with respect to each of the plurality of operation categories and the operation index with respect to each of the plurality of operation categories.

15. The content providing method of claim 11, wherein the updating includes updating the operation index by further considering relevance of the operation content with respect to each of the plurality of operation categories, in addition to at least one of the operation time or the operation frequency.

16. The content providing method of claim 15, wherein the relevance is determined based on whether at least one attribute value of metadata of the operation content satisfies a condition.

17. A content providing device comprising:
a communication unit configured to receive from a user terminal an operation signal with respect to operation content; and
a controller configured to:
calculate, according to the operation signal, at least one of an operation time or an operation frequency corresponding to the operation signal, the operation time being time spent for performing an operation;
update an operation index of the operation content with respect to at least one operation category corresponding to the operation, based on at least one of the operation time or the operation frequency; and
determine a ranking of the operation content with respect to the at least one operation category, based on the operation index.

18. The content providing device of claim 17, wherein the at least one operation category comprises a plurality of operation categories, and
the operation index is set for each of the plurality of operation categories.

19. The content providing device of claim 18, wherein the controller is further configured to:
set any one of the plurality of operation categories as a reference category;
determine a display order of one or more pieces of content according to rankings of the one or more pieces of content with respect to the reference category; and
display the one or more pieces of content according to the display order.

20. The content providing device of claim 18, wherein the controller is further configured to determine an overall ranking of the operation content based on the operation index of the operation content with respect to each of the plurality of operation categories.

21. The content providing device of claim 20, wherein the controller is further configured to determine the overall ranking based on a weight with respect to each of the plurality of operation categories and the operation index with respect to each of the plurality of operation categories.

22. The content providing device of claim 21, wherein the controller is configured to perform a first action regarding deletion when the overall ranking is lower than a first threshold ranking, and perform a second action regarding storage when the overall ranking is higher than a second threshold ranking,
wherein the first action includes at least one of displaying a message of recommending deletion of the operation content or performing deletion of the operation content, and
the second action includes at least one of displaying a message of recommending storage of the operation content or transmitting the operation content.

23. The content providing device of claim 18, wherein the controller is configured to update the operation index by further considering relevance of the operation content with respect to each of the plurality of operation categories, in addition to at least one of the operation time or the operation frequency.

24. The content providing device of claim 20, wherein the communication unit is further configured to transmit information about at least one of the ranking or the overall ranking to the user terminal.
